(19) United States
(12) Patent Application Publication
(10) Pub. No.: US 2017/0043286 A1
(43) Pub. Date: Feb. 16, 2017

(54) APPARATUS AND METHODS FOR RECYCLING FLUIDIC SUBSTANCES

(71) Applicant: SHIRHAO Limited, Hong Kong (HK)

(72) Inventor: Hao Chhoa, Hong Kong (HK)

(21) Appl. No.: 15/232,806

(22) Filed: Aug. 10, 2016

(30) Foreign Application Priority Data
Aug. 10, 2015 (HK) 15107723.2

(51) Int. Cl. B01D 35/28

(52) U.S. Cl. CPC B01D 35/28; F16N 39/06

(57) ABSTRACT

An apparatus and method for recycling fluidic substances. The apparatus of the present invention can recycle fluidic substance, comprising: at least one first container installed with at least one touching plate and a heating device; at least one second container installed with at least one touching plate and a heating device; and at least one third container installed with at least one touching plate, which is connected to a spinning or rotary device. The method for recycling fluidic substance by passing it through the said apparatus.

### CROSS-REFERENCE TO RELATED APPLICATIONS

This application claims the benefit of Hong Kong Patent Application No. 15107723.2 filed on Aug. 10, 2015; the contents of which is hereby incorporated by reference.

### FIELD OF THE INVENTION

The present invention relates to the apparatus and methods for recycling fluidic substances.

### BACKGROUND OF THE INVENTION

Present and future lubricant require high quality and high purity base oils at the point of use. The ever increasing revolutions per minute (rpm) and rating levels of modern lubricant and related mechanical apparatuses result in greater mechanical stress in lubricating materials and fluids. To handle these greater stresses, oils with better viscosity index qualities are required. Also lower residual water content in lubricant and material must be maintained. Therefore, the treatment and condition of oil throughout the process becomes critical to the efficiency and lifespan of industrial machine.

Typically, petroleum products used for industrial purposes are simply disposed of after use. In the United States alone, over 1.7 billion gallons of lubricating, hydraulic, and other petroleum products are disposed of each year, Napthenics Magazine, June 1996. Alternatively today, these petroleum products are expensively and inefficiently recycled. For example, to recycled 50,000 liters of oil, 5,000 Kg of adsorbents are needed which subsequently creates 8,000 Kg of oil saturated adsorbents for disposal. Without proper disposal, this amount of saturated adsorbents can contaminate 150,000 m² of drinking water.

Attempts have been made to improve the efficiency of petroleum fluid recycled applying either chemical or decoloring clay to the fluid after drying, for example using heat and/or a chemical wash, however these methods still produce less than desirable amounts of secondary pollution.

### SUMMARY OF THE INVENTION

An aspect of some embodiments of the invention relates to providing a plurality of vessels of matter adapted for the recycled of at least one fluidic substance. In some embodiments of the invention, the fluidic substance is petroleum based. In some embodiments of the invention, the fluidic substance is a refrigerant and/or coolant. In some embodiments of the invention, the fluidic substance is de-ionized water and/or some other non-conducting fluid.

In an embodiment of the invention, selected sequencing are presented (e.g. the fluidic substance flows onto the specified apparatus in a specific order, for example fluid flows onto first vessel in the direction of flow of the fluidic substance. In some embodiments of the invention, the fluid flows in a vessel in the specific order wherein the fluidic substance is passed through from one vessel to the next vessel, and in a desired sequence of exposure to the contact surface area of the vessel.

In some embodiments of the invention, the proportion of the fluid droplet sizes of the total amount are dependent on the type of fluidic substance being recycled. Type is determined, for example, by ISO Viscosity Grade and/or the kind of fluid (e.g. lubricating, hydraulic, and/or other petroleum products, water, refrigerant and/or coolant fluids, etc.) and/or the pH of the fluid being recycled.

An aspect of some embodiments of the invention relates to providing an apparatus for recycling fluidic substances including a universal particle filtration section and/or purification section. The filtration screen collects both metallic and non-metallic particles, in an embodiment of the invention. In some embodiments of the invention, the universal particle filtration section are combined into one section. In some embodiments of the invention, the purification section is used for removing particulate matter, gas and/or moisture from the fluid being recycled. The universal particle filtration section, when both are used in the apparatus, is not critical in some embodiments of the invention, allowing for either section to be used before the other but both before the recycled section. In an embodiment of the invention, the purification section acts on the fluid being recycled before the fluid enters the recycled section.

In some embodiments of the invention, the recycled section includes a prioritization of matter comprised of sequencing vessels which are selected and/or are arranged for recycled of a specific fluidic substance. In an embodiment of the invention, the recycled section is comprised of at least three (3) vessels stack together to form one master vessel wherein the fluidic substance being recycled flows into the vessels, through the at least one vessel and/or is recirculated through the next vessel until the fluidic substance has been recycled to or above a predetermined threshold, for example a threshold of quality.

In an embodiment of the invention, the touching plate is constructed of a substance with different shape and form which does not adversely react with the fluid being recycled. In embodiments a metal is used for constructing the touching plate, for example aluminum, carbon steel, copper or stainless steel.

An aspect of some embodiments of the invention relates to providing a universal particle filtration section, adapted for regulating fluid flow and/or filtering debris.

In some embodiments of the invention, the size of particles which are filtered is determined by the type of fluid being filtered, for example fluids with high ISO viscosity grades (ISO viscosity grades being one way of determining type) are filtered for particles as small as 1 micron. In some embodiments of the invention, the conical filter is provided with pores adapted for filtering out debris as small as 1 micron. In some embodiments of the invention, the filter is provided with pores adapted for filtering out debris as small as 0.5 microns.

In an embodiment of the invention, the touching plate shape of the circular flat plate and concave ellipse is used to regulate fluid flow as it transitions from one vessel to the next vessel section, to a recycled section in a fluid recycled apparatus. In an embodiment of the invention, the circular flat plate assembly is divided into a first portion upstream of the metal circular flat plate, uphold by a metal circular tube which enwrapped by inducting heating or any other ways of heating or heating media and a second portion downstream of the metal plate in the shape and form of concave ellipse, uphold by a metal circular tube which enwrapped by inducting heating or any other ways of heating or heating media and lastly third portion downstream of the metal plate in the shape and form of a concave circle or wine glass (with open to the top) which incorporate with a motor (which is powered and controlled by an internal or external power source and control unit) at the bottom of it such that the said concave circle or wine glass will spin or rotate at a speed at or higher than 1,000 rpm. In some embodiments of the invention, the velocity of flow in the first portion is slowed as the fluid passes through onto the circular flat plate then concave ellipse and finally onto the concave circle or wine glass (with open to the top) shape. In some embodiments of the invention, the flow velocity in the second portion increases as the fluid progresses past onto the concave ellipse touching plate and then onto the third touching plate with the shape and form of a concave circle or wine glass (with open to the top) that has a motor (which is powered and controlled by an internal or external power source and control unit) at the bottom of it. The said motor is connected with the said concave circle or wine glass such that the said concave circle or wine glass will spin or rotate at a speed at or higher than 1,000 rpm. In such an embodiment of the invention, the inlet flow rate and the outlet flow rate are the same; however, the flow velocity is different between the upstream and downstream portions.

An aspect of some embodiments of the invention relates to providing a method for recycling at least one fluidic substance, the method including at least passing the fluidic substance through stages of recycling, optionally arranged in top/down and/or additionally or alternatively in a predefined sequence. In some embodiments of the invention, each component is selected to perform a different effect on the fluidic substance, examples including reducing acidity, as a desiccant, and/or for removing sulfur. In some embodiments of the invention, the droplet size of the fluid are used to provide a cumulative effect on the fluidic substance, for example continuing to reduce acidity as the fluid touches the heated touching plate. In an embodiment of the invention, the fluid being recycled is passed onto the at least one vessel at least one time in order to recycled the fluid. Additionally, alternatively and/or optionally, the fluid is passed through a universal filter for filtering out debris greater than a certain size.

There is further provided in accordance with an exemplary embodiment of the invention an apparatus for recycling fluidic substances, comprising: a recycled section containing therein a vessel of matter according to any one of exemplary embodiments described above. In an embodiment of the invention, the apparatus further comprises at least one of a filtration section or a universal particle filtration section. Optionally, the recycled section is comprised of at least one recycled vessel. Optionally, the recycled vessel is adapted for flow of the fluidic substances there through. Optionally, the master vessel section is comprised of a three (3) independent vessels assembly provided with a clamp to hold together. Optionally, the three (3) independent vessels section are combined in a single section. Optionally, the fluidic substances being recycled flow through at least one of the vessel section prior to flowing through the after sequence vessel section. Optionally, the fluidic substances being recycled are recirculated through at least one of the vessel section.

There is further provided in accordance with an exemplary embodiment of the invention a universal particle filtration section for filtering particles from a fluidic substance passing therethrough, comprising: an upstream portion adjacent to an inlet to the universal particle filtration section; and, a downstream portion adjacent to an outlet of the universal particle filtration section.

There is further provided in accordance with an exemplary embodiment of the invention method for recycling at least one fluidic substance, comprising: passing the at least one fluidic substance through a vessel of matter according to any one of exemplary embodiments described above. In an embodiment of the invention, the method further comprises passing the at least one fluidic substance through a master vessel in sequencing. In an embodiment of the invention, the method further comprises passing the at least one fluidic substance through a universal filter for filtering out debris greater than a certain size. In an embodiment of the invention, the method further comprises selecting at least one of: i) the sequence of the vessels; based on the type of fluidic substance being recycled. Optionally, type is defined by viscosity. Optionally, type is defined by pH. Optionally, type is defined by the kind of fluid being recycled. Optionally, kind is selected from a group comprising lubricating fluids, hydraulic fluids, petroleum products, and water, refrigerant or coolant fluids.

### BRIEF DESCRIPTION OF THE FIGURES

Non-limiting embodiments of the invention will be described with reference to the following description of exemplary embodiments, in conjunction with the Figures. The Figures are generally not shown to scale and any measurements are only meant to be exemplary and not necessarily limiting. In the Figures, identical structures, elements or parts which appear in more than one Figure are preferably labeled with a same or similar number in all the Figures in which they appear, in which:

FIG. 1 is a block diagram showing generally the sections of an apparatus for recycling fluidic substances, in accordance with an exemplary embodiment of the invention;

FIG. 2 is a cross-sectional view of a vessel section with the touching plate in the shape of the circular flat plate.

FIG. 2a is the top view and FIG. 2b is the side view.

FIG. 2c is a cross-sectional view of a vessel section with the touching plate in the shape of the circular flat plate in accordance with an exemplary embodiment of the invention;

FIG. 3 is a cross-sectional view of a vessel section with the touching plate in the shape and form of concave ellipse (with respect to the bottom of the said vessel section) or a cone.

FIG. 3a is the top view and FIG. 3b is the side view.

FIG. 3c is a cross-sectional view of a vessel section with the touching plate in the shape and form of concave ellipse (with respect to the bottom of the said vessel section) or a cone in accordance with an exemplary embodiment of the invention;

FIG. 4 is a cross-sectional view of a vessel section with the touching plate in the shape and form of a concave circle or wine glass (with open to the top) which incorporate with a motor (which is powered and controlled by an internal or external power source and control unit) at the bottom of it such that the concave circle or wine glass will spin or rotate.

FIG. 4a is the top view and FIG. 4b is the side view.

FIG. 4c is a cross-sectional view of a vessel section with the touching plate in the shape and form of a concave circle or wine glass (with open to the top) which incorporate with a motor (which is powered and controlled by an internal or external power source and control unit) at the bottom of it such that the said concave circle or wine glass will spin or rotate, in accordance with an exemplary embodiment of the invention;

FIG. 5 is a cross-sectional view of a master vessel section with vessels stack together by a clamp from top vessel Vessel-A (FIG. 2), in the middle vessel Vessel-B (FIG. 3) and the bottom vessel Vessel-C (FIG. 4), or their combinations.

FIG. 5b is a cross-sectional view of a master vessel section with three vessels stack together by a clamp from top vessel Vessel-A (FIG. 2), in the middle vessel Vessel-B (FIG. 3) and the bottom vessel Vessel-C (FIG. 4) in accordance with an exemplary embodiment of the invention.

### DETAILED DESCRIPTION OF EXEMPLARY EMBODIMENTS

In some embodiments of the invention, a vessel of matter and/or a plurality of vessels of matter are selected to be used for the recycled of a fluidic substance. The fluidic substance is petroleum based, in some embodiments of the invention. In some embodiments of the invention, the fluidic substance is a refrigerant and/or coolant. In some embodiments of the invention, the fluidic substance is de-ionized water and/or some other non-conducting fluid.

As used in this application, recycled generally means returning at least one desired property of the fluidic substance to a pre-used level, for example fluidic substances are recycled to restore their purity in some embodiments of the invention. In some embodiments of the invention, the viscosity of the fluidic substance is altered by removing moisture. In some embodiments of the invention, the acidity of the fluidic substance is altered by removing particles from the substance. In some embodiments of the invention, the color of the fluidic substance is changed by removing particles from the fluid. In some embodiments of the invention, recycled using the herein described vessels of matter improves at least one property to and/or above its pre-use level, indicating the possible utility of these vessels as a final step in the original processing of the fluidic substance.

In an embodiment of the invention, a vessel of matter is comprised of selected and herein described master vessel. In an embodiment of the invention, the fluidic substance being recycled is passed through the vessels in sequence. In some embodiments of the invention, each vessel is selected to perform a different effect on the fluidic substance being recycled, examples including reducing acidity, as a desiccant, and/or for removing sulfur. In some embodiments of the invention, a plurality of vessels are used to provide a cumulative effect on the fluidic substance, for example continuing to reduce acidity as the fluid passes through the plurality of vessels. In some embodiments of the invention, vessels are chosen and placed in order using a determining factor such as molecular weight of the respective vessels. Optionally, at least one of the vessel is itself a vessel of a plurality of components.

In an embodiment of the invention, selected vessels are presented (e.g. the fluidic substance flows through the vessels) to the fluidic substance being recycled in a specific order, for example Vessel-A preceding Vessel-B and Vessel-C in the direction of flow of the fluidic substance. In some embodiments of the invention, the Master vessel is laid in at least one vessel in the specific order wherein the fluidic substance is passed through the at least one vessel, and therefore the vessel, in a desired sequence of exposure to the touching plate of vessels.

In some embodiments of the invention, the proportion of the total amount and/or selection of vessels are dependent on the type fluidic substance being recycled. Type is determined, for example, by ISO Viscosity Grade and/or the kind of fluid (e.g. lubricating, hydraulic, and/or other petroleum products, water, refrigerant and/or coolant fluids, etc.) and/or the pH of the fluid being recycled.

In general, the dirtier a fluid being recycled is the more total amount of that need recyclable pass that need to be used in order to recycle the fluid.

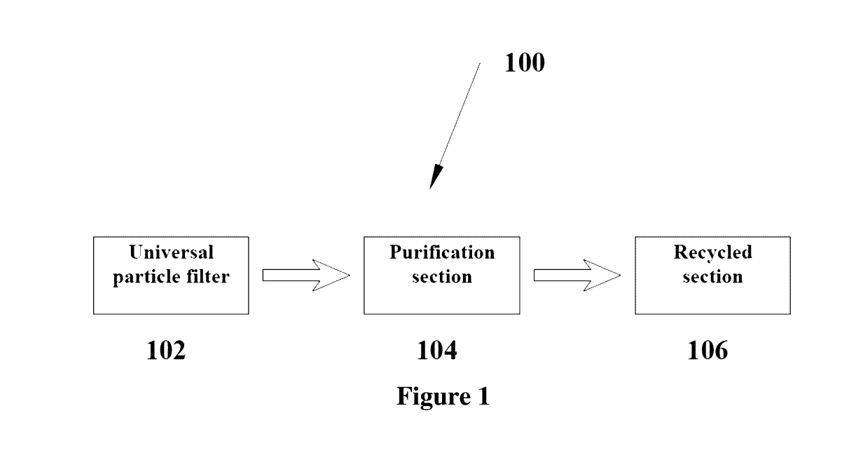

FIG. 1 is a block diagram showing generally the sections of an apparatus 100 for recycling fluidic substances, in accordance with an exemplary embodiment of the invention. In an embodiment of the invention, apparatus 100 is comprised of a recycled section 106. Additionally, alternatively and/or optionally, apparatus 100 is provided with a universal particle filtration section 102 and/or a purification section 104.

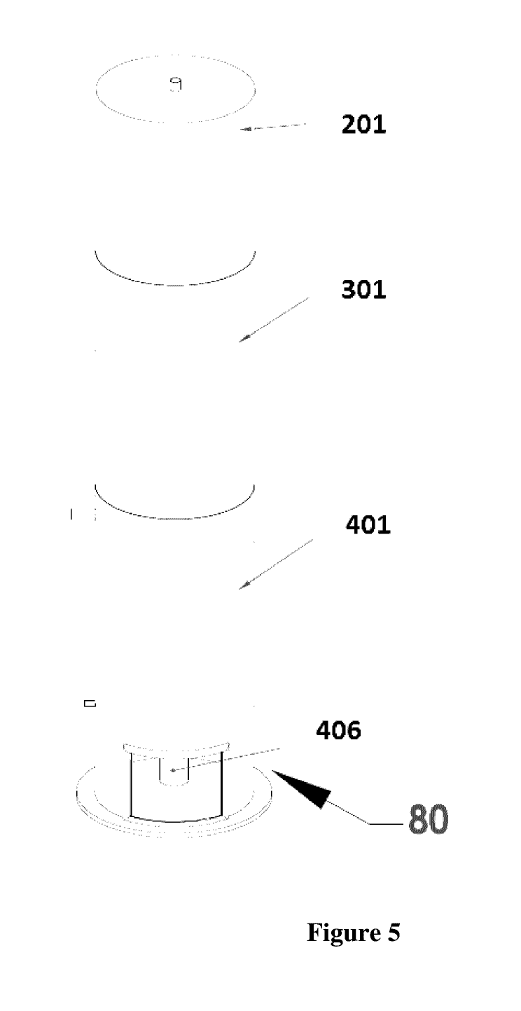

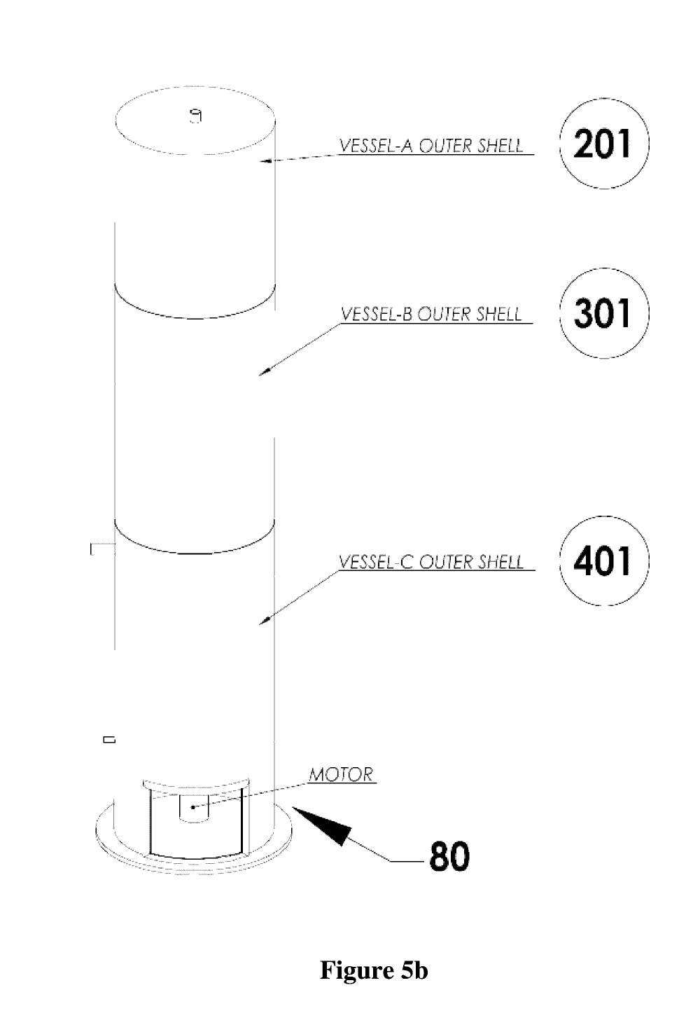

In an embodiment of the invention, recycled section 106 is comprised of at least one vessel (an example shown in more detail with respect to FIG. 5) with the vessels situated therein wherein the fluidic substance being recycled flows into the at least one vessel, through the vessels and/or is recirculated through the vessels until the fluidic substance has been recycled to or above a predetermined threshold, for example a threshold of quality. Optionally, the vessels are arranged in such as the recycled vessel described with respect to FIG. 5. In some embodiments of the invention, a plurality of vessels, each containing at least one of the vessels, is used for recycling the fluid passing there through. Optionally, the plurality of vessels is arranged in a predefined sequence.

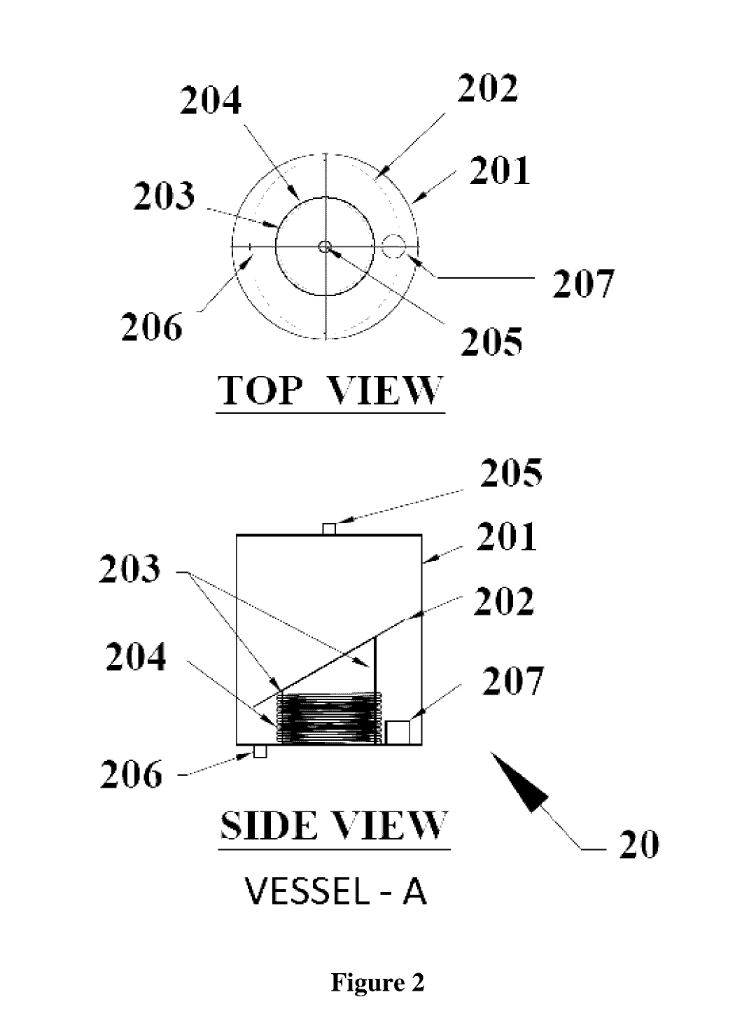

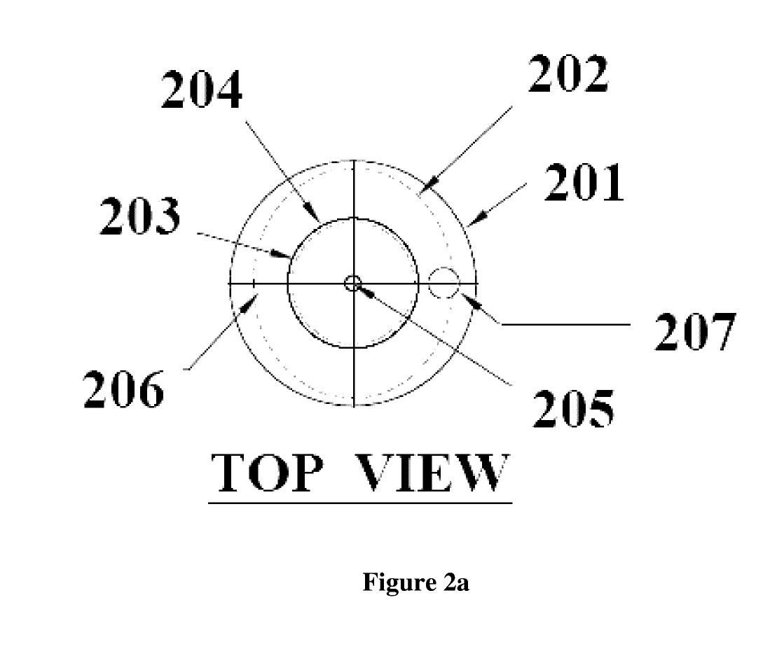

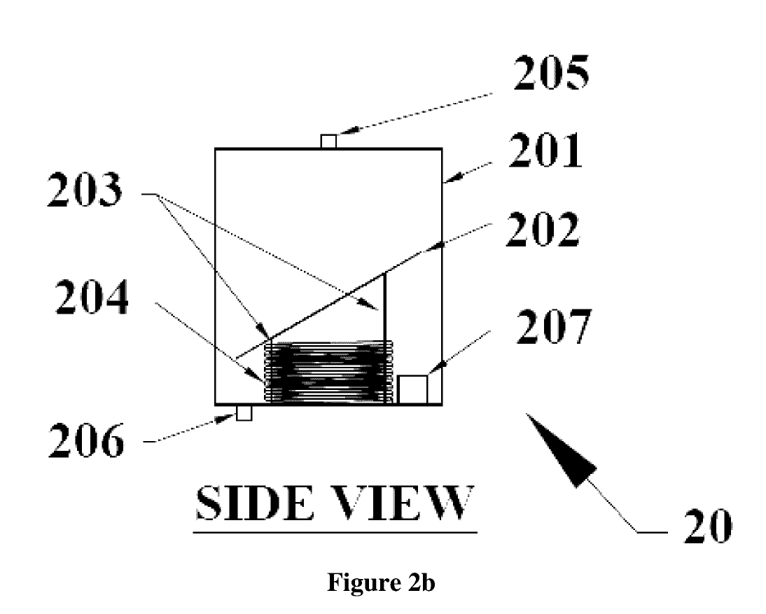

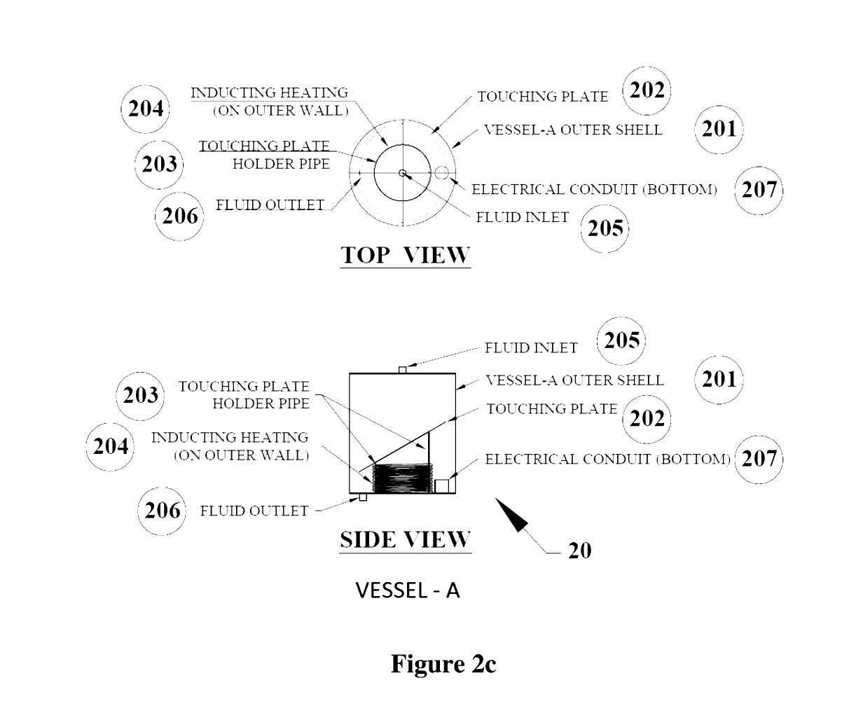

In an embodiment of the invention, “Vessel-A” (FIG. 2) is actually comprised of a touching plate shape of the circular flat plate which has holding tube with inducting heating or any other ways of heating or heating media on it, in an embodiment of the invention.

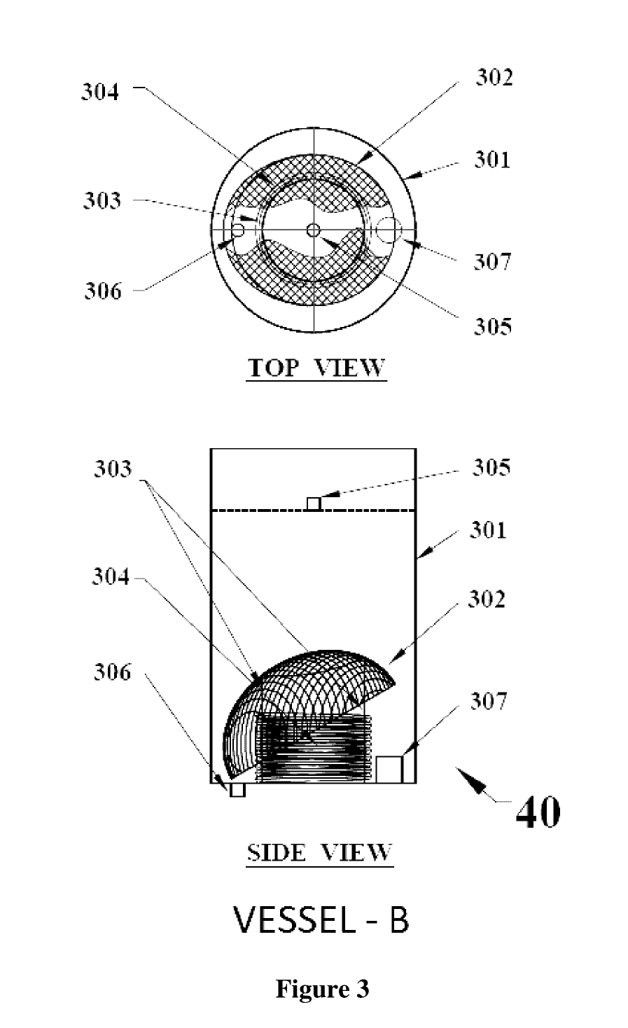

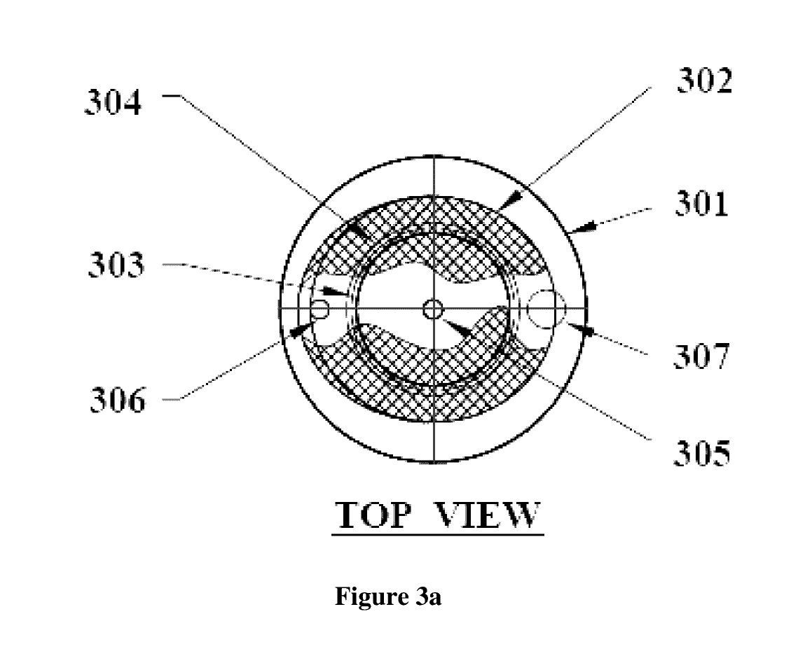

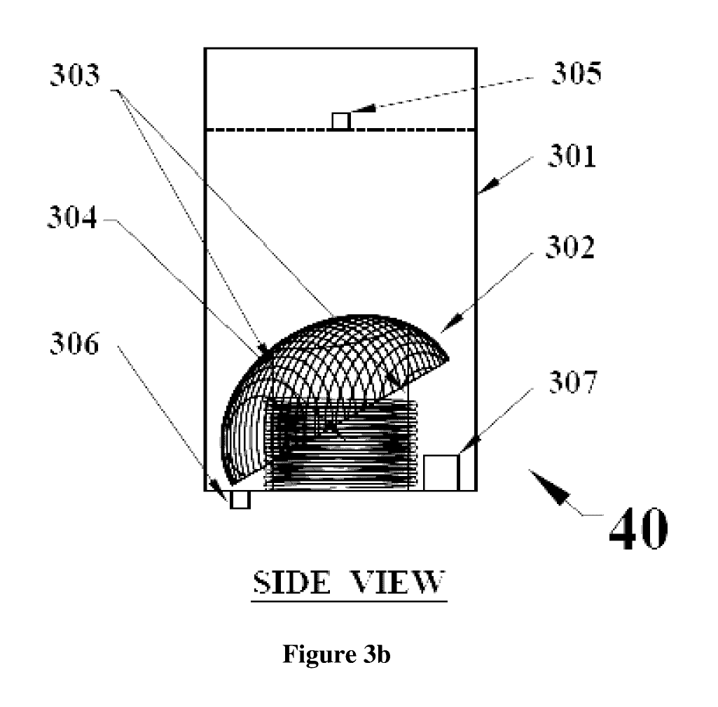

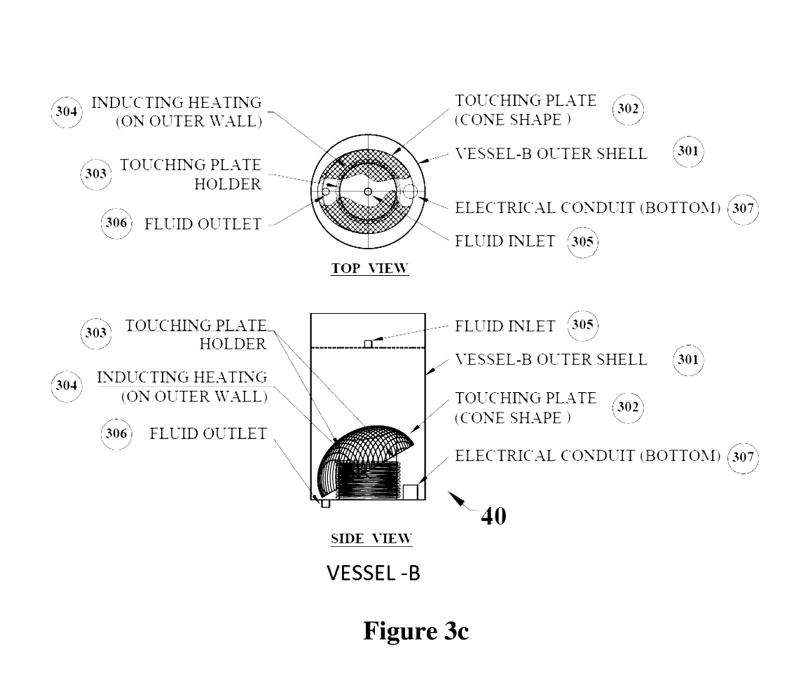

In an embodiment of the invention, “Vessel-B” (FIG. 3) is actually comprised of a touching plate in the shape and form of concave ellipse (with respect to the bottom of the vessel) or cone which has holding tube with inducting heating or any other ways of heating or heating media on it, in an embodiment of the invention.

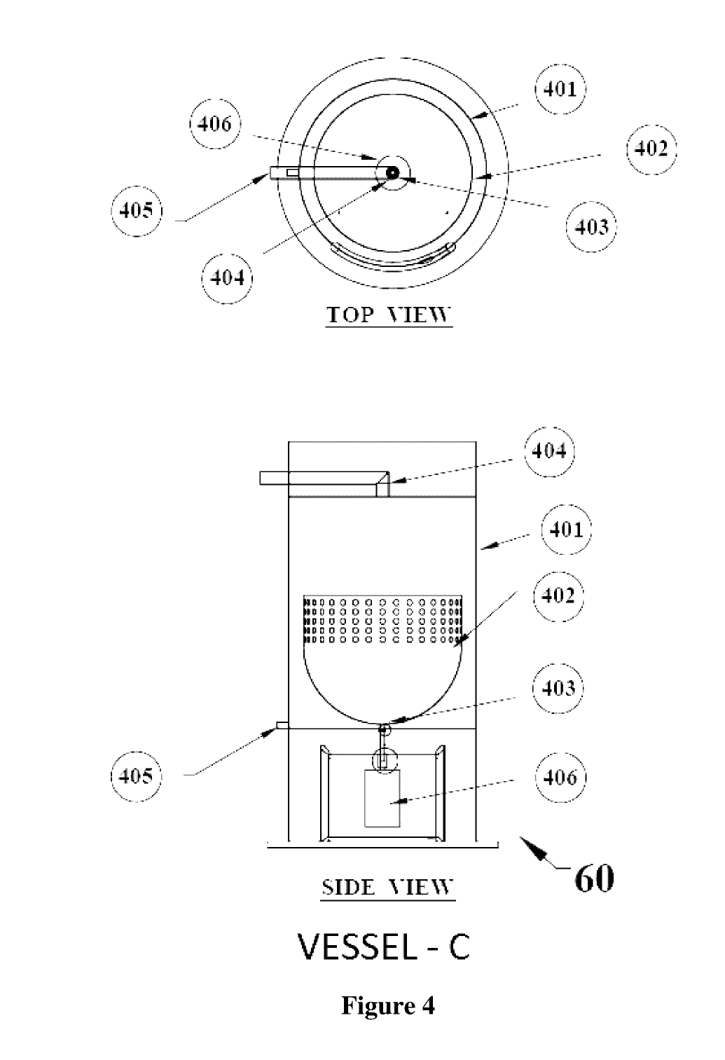

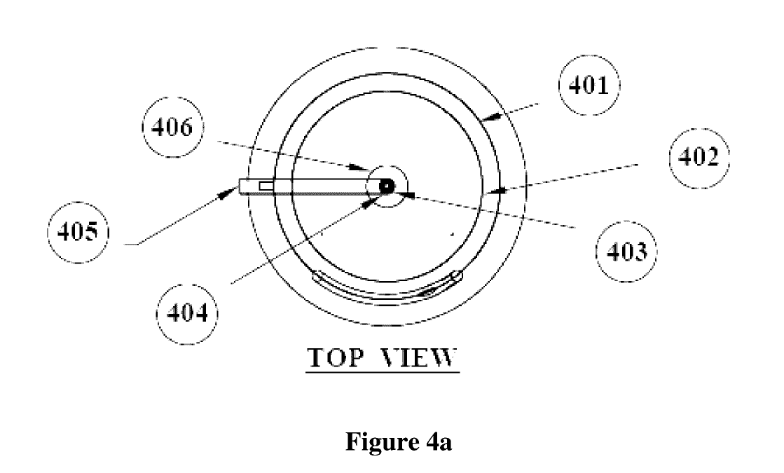

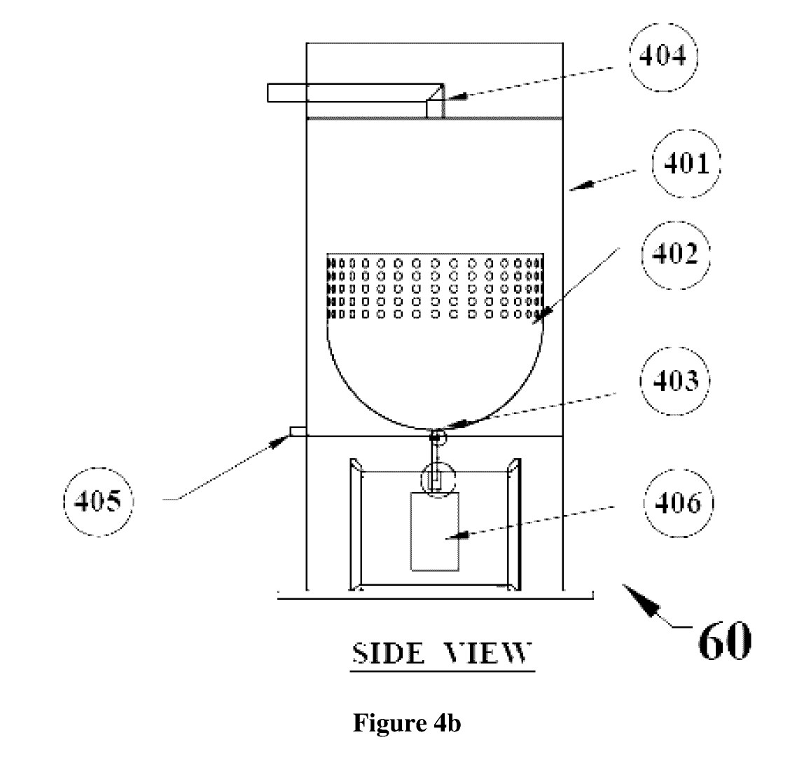

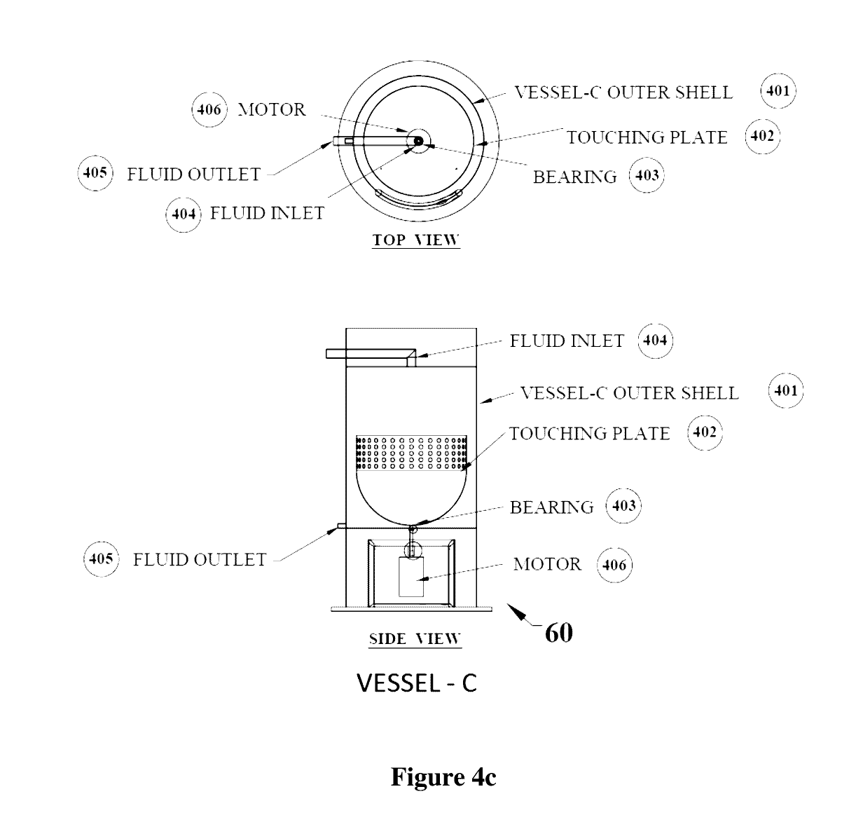

In an embodiment of the invention, “Vessel-C” (FIG. 4) is actually comprised of a touching plate in the shape and form of a concave circle or wine glass (with open to the top) which incorporate with a motor (which is powered and controlled by an internal or external power source and control unit) at the bottom of it such that the said concave circle or wine glass will spin or rotate at a speed at or higher than 1,000 rpm, in an embodiment of the invention.

In some embodiments of the invention, Vessel-A, Vessel-B and/or Vessel-C are sized to enable efficient flow through apparatus. Optionally, apparatus 106 is portable for use in a plurality of locations. In some embodiments of the invention, at least any two of Vessel-A, Vessel-B and/or Vessel-C are combined into one section. Additionally, alternatively and/or optionally, Vessel-A, Vessel-B and/or Vessel-C do not necessarily need to be arranged in a specific order.

Referring to FIG. 2, a cross-sectional view of Vessel-A section 20 is shown, in accordance with an exemplary embodiment of the invention. Vessel-A section 20 is provided with a pipe tube section housing, Vessel-A outer shell 201 which is adapted for flow of the fluidic substance therethrough and/or for the safe operation features of the touching plate 202, in an embodiment of the invention. An inlet 205 and/or an outlet 206 are provided to the housing 201 for the introduction and removal of the fluidic substance being recycled. In some embodiments of the invention, at least the inducting heating on outer wall 204 or any other ways of heating or heating media is used to generate heat when charged by any sort of internal or external power sources. As seen in more detail in FIG. 2, the at least touching plate 202 is welded onto touching plate holder pipe 203 and place into section housing Vessel-A outer shell 201. In an embodiment of the invention, the fluidic substance being recycled enters Vessel-A section 20 at inlet 205 and flows in a direction towards outlet 206, thereby passing by and/or around at least on touching plate 202.

It should be understood that while the present application describes a recyclable section, it is by way of example only, and that any solution known to those skilled in the art are useable to remove unwanted element from the fluidic substance being recycled.

Referring to FIG. 3, a cross-sectional view of Vessel-B section 40 is shown, in accordance with an exemplary embodiment of the invention. Vessel-B section 40 is provided with a pipe tube section housing, Vessel-B outer shell 301 which is adapted for flow of the fluidic substance there through and/or for the safe operation features of the touching plate 302, in an embodiment of the invention. An inlet 305 and/or an outlet 306 are provided to the housing 301 for the introduction and removal of the fluidic substance being recycled. In some embodiments of the invention, at least the inducting heating on outer wall 304 or any other ways of heating or heating media is used to generate heat when charged by any sort of internal or external power sources. As seen in more detail in FIG. 3, the at least touching plate 302 is welded onto touching plate holder pipe 303 and place into section housing Vessel-B outer shell 301. In an embodiment of the invention, the fluidic substance being recycled enters Vessel-B section 40 at inlet 305 and flows in a direction towards outlet 306, thereby passing by and/or around at least on touching plate 302.

It should be understood that while the present application describes a recyclable section, it is by way of example only, and that any solution known to those skilled in the art are useable to remove unwanted element from the fluidic substance being recycled.

Referring to FIG. 4, a cross-sectional view of Vessel-C section 60 is shown, in accordance with an exemplary embodiment of the invention. Vessel-C section 60 is provided with a pipe tube section housing, Vessel-C outer shell 401 which is adapted for flow of the fluidic substance there through and/or for the safe operation features of the touching plate 402, in an embodiment of the invention. An inlet 404 and/or an outlet 405 are provided to the housing 401 for the introduction and removal of the fluidic substance being recycled. In some embodiments of the invention, at least the bottom of touching plate 402 will be fasten onto or connected to a motor 406 (which is powered and controlled by an internal or external power source and control unit) such that touching plate 402 will spin or rotate at the speed at or higher than 1,000 rpm. As seen in more detail in FIG. 4, the at least touching plate 402 is fasten onto motor shaft 406 and place into section housing Vessel-C outer shell 401. In an embodiment of the invention, the fluidic substance being recycled enters Vessel-C section 60 at inlet 404 and flows in a direction towards outlet 405, thereby passing by and/or around at least on touching plate 402.

It should be understood that while the present application describes a recyclable section, it is by way of example only, and that any solution known to those skilled in the art are useable to remove unwanted element from the fluidic substance being recycled.

FIG. 5 is an assembly diagram showing generally the sections of an apparatus 100 for recycling fluidic substances, in accordance with an exemplary embodiment of the invention. In an embodiment of the invention, apparatus 100 is comprised of a recycled section 80 (FIG. 5). Additionally, alternatively and/or optionally, apparatus 100 is provided with a Vessel-A (FIG. 2) section 20, Vessel-B (FIG. 3) section 40 and Vessel-C (FIG. 3) section 60 which stack together and form the Master Vessel (FIG. 5) section 80.

The wordings “vessel” or “vessel of matter” shall not limit the form of the vessel in its ordinary meaning but the said vessel or vessel of matter could be any container in any form or shape which could contain or install the touching plates or the components in connection with the said touching plates in the vessels including Vessel-A, Vessel-B or Vessel-C.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. When used in the following claims, the terms “comprises”, “includes”, “have” and their conjugates mean “including but not limited to”. It should also be noted that the device is suitable for both males and female, with male pronouns being used for convenience. The scope of the invention is limited only by the following claims.

1. An apparatus for recycling a fluidic substance, comprising:
a) at least one first container installed with at least one touching plate, with or without slope, in any shape or form, and a heating device such that the said touching plate is heated;
b) at least one second container installed with at least one touching plate, with or without slope, and in any shape or form, and a heating device such that the said touching plate is heated; and
c) at least one third container installed with at least one touching plate, in any shape or form, which is connected to a spinning or rotary device such that the said touching plate spins or rotates at certain speed;
and there are at least one inlet and one outlet provided to each of the said first, second or third container for the introduction and removal of the fluidic substance being recycled;
and the said first container is connected preceding the said second container, the second container is connected preceding the third container, in the direction of flow of the fluidic substance being recycled.

2. An apparatus according to claim 1, wherein the said heating device heats the said container or touching plate by way of inducting heating or other heating media installed in or outside the said container.

3. An apparatus according to claim 1, wherein the said touching plate of the first or second container conforms with the shape or form of flat plate, circular flat plate, concave ellipse or concave circle with respect to the bottom of the said container, concave with respect to the bottom of the said container, cone, convex with open in the top or wine glass with open in the top.

4. An apparatus according to claim 1, wherein the said touching plate of the third container conforms with the shape or form of convex with open in the top or wine glass with open in the top.

5. An apparatus according to claim 1, where the said spinning or rotary device contains at least one motor with the shaft of the said motor or gears fasten to the said touching plate such that the said touching plate spins or rotates in certain speed.

6. An apparatus according to claim 1, where the said speed is at least 1,000 revolutions per minute (rpm).

7. A master apparatus according to claim 1, wherein each apparatus forms a stack in a sequence.

8. An apparatus for recycling fluidic substances, comprising:
A recycled section containing therein the said apparatus according to claim 1.

9. An apparatus according to claim 8, where the recycled vessel is adapted for flow of the fluidic substances therethrough.

10. A method for recycling at least one fluidic substance, comprising the steps of:
passing the at least one type of fluidic substance through the apparatus according to claim 1.

11. The method according to claim 10, further comprising passing the at least one fluidic substance through preceding a filter for filtering out metallic debris.

12. The method according to claim 10, further comprising passing the at least one fluidic substance through a universal filter for filtering out debris greater than a certain size.

13. The method according to claim 10, further comprising selecting at least one of:
a) the said containers for the said apparatus;
b) the proportions of the said containers; or
c) the sequence of the said containers;
based on the type of fluidic substance being recycled.

14. The method according to claim 10, wherein the said type of fluidic substance is defined by viscosity.

15. The method according to claim 10, wherein the said type of fluidic substance is defined by pH.

16. The method according to claim 10, wherein the said type of fluidic substance is defined by the kind of fluid being recycled.

17. The method according to claim 10, wherein the said type of fluidic substance is selected from a group comprising lubricating fluids, hydraulic fluids, petroleum products, water, refrigerant or coolant fluids.

18. A universal particle filtration section for filtering particles from a fluidic substance passing there through preceding the apparatus in claim 1, comprising:
an upstream portion adjacent to an inlet to the universal particle filtration section; and
a downstream portion adjacent to an outlet of the universal particle filtration section;
wherein the upstream and downstream portions are divided by a touching plate assembly.

19. A universal particle filtration section according to claim 18, wherein the filter element assembly is provided with pores for filtering particles larger than 5 microns in diameter.

20. A universal particle filtration section according to claim 18, wherein the filter element assembly is provided with pores for filtering particles larger than 1 micron in diameter.

21. A universal particle filtration section according to claim 18, wherein the filter element assembly is provided with pores for filtering particles larger than 0.5 microns in diameter.
